(19) United States
(12) Patent Application Publication
(10) Pub. No.: US 2025/0164595 A1
(43) Pub. Date: May 22, 2025

(54) RADIO WAVE CONDITION OUTPUT DEVICE, RADIO WAVE CONDITION OUTPUT METHOD, AND RADIO WAVE CONDITION OUTPUT PROGRAM

(71) Applicant: NIPPON TELEGRAPH AND TELEPHONE CORPORATION, Tokyo (JP)

(72) Inventors: Masafumi YOSHIOKA, Musashino-shi, Tokyo (JP); Fumiaki NAGASE, Musashino-shi, Tokyo (JP); Keita KURIYAMA, Musashino-shi, Tokyo (JP); Toshifumi MIYAGI, Musashino-shi, Tokyo (JP)

(73) Assignee: NIPPON TELEGRAPH AND TELEPHONE CORPORATION, Tokyo (JP)

(21) Appl. No.: 18/840,917

(22) PCT Filed: Feb. 24, 2022
(86) PCT No.: PCT/JP2022/007702

§ 371 Date: Aug. 23, 2024

(51) Int. Cl. G01S 3/14

(52) U.S. Cl. CPC G01S 3/14

(57) ABSTRACT

A radio wave status output device has: a measurement circuitry that measure each reception power or a C/N value of a radio wave received; an angle measurement circuitry that measure each an azimuth angle and an elevation angle of the directional antenna; a calculation circuitry that calculate an approximate curved surface corresponding to each the reception power or C/N value at a position of each of the plurality of different points on an X-Y plane, respectively, and that the reception power or the C/N value measured is a value of a Z-axis; and an extraction circuitry that extract, from the approximate curved surface calculated, a range on the X-Y plane in which the value of the Z-axis is equal to or greater than a predetermined threshold.

### TECHNICAL FIELD

The present invention relates to a radio wave status output device, a radio wave status output method, and a radio wave status output program.

### BACKGROUND ART

Many methods have been proposed as methods of estimating an arrival direction of radio waves in wireless communication. For example, a method using a phase difference among radio waves based on a difference in antenna position, a multiple signal classification (MUSIC) method, and the like are dominantly proposed, and there is a method by which an arrival direction of radio waves on a horizontal plane can be estimated by changing a direction of a main lobe or a null point of an antenna pattern (for example, see Non Patent Literature 1).

In the related art, radio waves arriving from three-dimensional directions are not assumed, and the arrival direction of radio waves is estimated based on a correlation matrix obtained using an array antenna. That is, a planar direction of arrival has been estimated.

### CITATION LIST

### Non Patent Literature

Non Patent Literature 1: Minseok Kim, “Torai hoko suitei sisutemu no kiso to jissorei (in Japanese) (Basics and Implementation of Direction-of-Arrival Estimation System)”, Design Wave Magazine, 2007 December, pp. 112-118.

### SUMMARY OF INVENTION

### Technical Problem

However, the arrival direction of radio waves is not limited to the horizontal direction. For example, it is assumed that radio waves arrive also from the vertical direction due to situations such as diffraction and reflection. Therefore, in order to more accurately grasp the radio wave status such as the arrival direction of radio waves, it is necessary to consider the radio waves arriving from the vertical direction.

The present invention is contrived in view of the above-described problem, and an object of the present invention is to provide a radio wave status output device, a radio wave status output method, and a radio wave status output program capable of making it possible to easily grasp a three-dimensional radio wave status.

### Solution to Problem

A radio wave status output device according to one embodiment of the present invention has: a measurement unit that measures, in a case where a directional antenna is directed to each of a plurality of different points positioned on a plane orthogonal to a reference straight line extending in a horizontal direction, each reception power or a C/N value of a radio wave received by the directional antenna; an angle measurement unit that measures an azimuth angle and an elevation angle of the directional antenna in a case where the directional antenna is directed to each of the plurality of different points; a calculation unit that calculates an approximate curved surface corresponding to either the reception power or C/N value at a position of each of the plurality of different points on an X-Y plane, based on an assumption that the azimuth angle and the elevation angle measured by the angle measurement unit with respect to each of the plurality of different points are a value of an X-axis and a value of a Y-axis, respectively, and that the reception power or the C/N value measured by the measurement unit is a value of a Z-axis; an extraction unit that extracts, from the approximate curved surface calculated by the calculation unit, a range on the X-Y plane in which the value of the Z-axis is equal to or greater than a predetermined threshold; and an output unit that outputs the range on the X-Y plane extracted by the extraction unit.

In addition, a radio wave status output method according to tone embodiment of the present invention includes: a measurement step of measuring, in a case where a directional antenna is directed to each of a plurality of different points positioned on a plane orthogonal to a reference straight line extending in a horizontal direction, either reception power or a C/N value of a radio wave received by the directional antenna; an angle measurement step of measuring an azimuth angle and an elevation angle of the directional antenna in a case where the directional antenna is directed to each of the plurality of different points; a calculation step of calculating an approximate curved surface corresponding to each the reception power or C/N value at a position of each of the plurality of different points on an X-Y plane, based on an assumption that the azimuth angle and the elevation angle measured with respect to each of the plurality of different points are a value of an X-axis and a value of a Y-axis, respectively, and that the reception power or the C/N value measured is a value of a Z-axis; an extraction step of extracting, from the calculated approximate curved surface, a range on the X-Y plane in which the value of the Z-axis is equal to or greater than a predetermined threshold; and an output step of outputting the extracted range on the X-Y plane.

### Advantageous Effects of Invention

According to the present invention, it is possible to easily grasp a three-dimensional radio wave status.

### BRIEF DESCRIPTION OF DRAWINGS

FIG. 1 is a diagram showing a configuration example of a radio wave status output device according to one embodiment.

FIG. 2(a) is a diagram illustrating a plurality of different points positioned on a plane orthogonal to a reference straight line extending in a horizontal direction. FIG. 2(b) is a diagram illustrating a result of the extraction of a range on an X-Y plane by an extraction unit to be described later using the plurality of different points.

FIG. 3 is a flowchart showing an operation example of the radio wave status output device according to one embodiment.

FIG. 4 is a diagram showing a configuration example of a modification example of the radio wave status output device according to one embodiment.

FIG. 5(a) is a diagram illustrating a plurality of different points positioned on a plane orthogonal to a reference straight line extending in a horizontal direction. FIG. 5(b) is a diagram illustrating a result of the extraction of a range on an X-Y plane by an extraction unit to be described later using the plurality of different points.

FIG. 6 is a flowchart showing an operation example of the modification example of the radio wave status output device according to one embodiment.

FIG. 7 is a diagram showing a hardware configuration example of the radio wave status output device 1 according to one embodiment.

### DESCRIPTION OF EMBODIMENTS

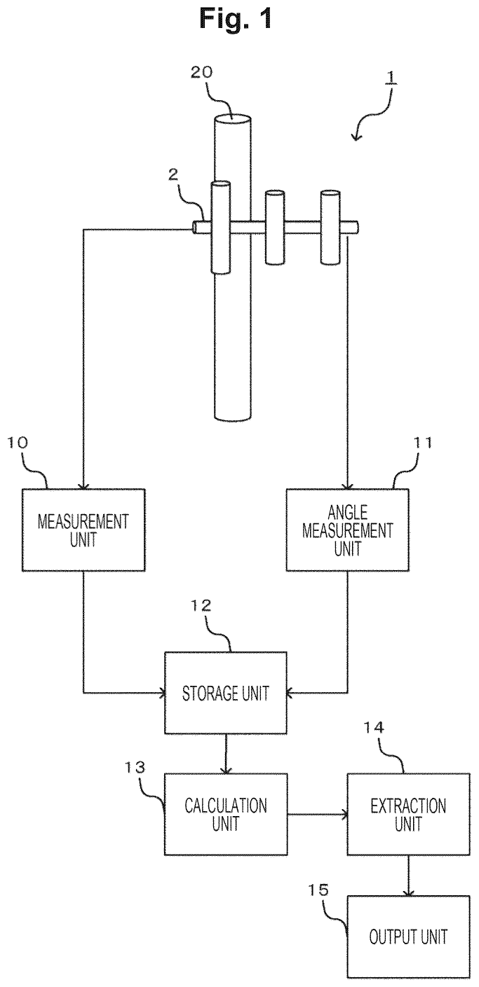

Hereinafter, a configuration example of a radio wave status output device 1 according to one embodiment will be described with reference to the drawings. FIG. 1 is a diagram showing a configuration example of the radio wave status output device 1 according to one embodiment.

As shown in FIG. 1, the radio wave status output device 1 according to one embodiment has, for example, a directional antenna 2, a measurement unit 10, an angle measurement unit 11, a storage unit 12, a calculation unit 13, an extraction unit 14, and an output unit 15.

The directional antenna 2 is fixed to a fixing unit 20, receives a radio wave, and outputs reception power to the measurement unit 10.

In a case where the directional antenna 2 is directed to each of a plurality of different points positioned on a plane orthogonal to a reference straight line extending in the horizontal direction, the measurement unit 10 measures either reception power or a C/N value of the radio wave received by the directional antenna 2, and outputs the reception power or C/N value to the storage unit 12.

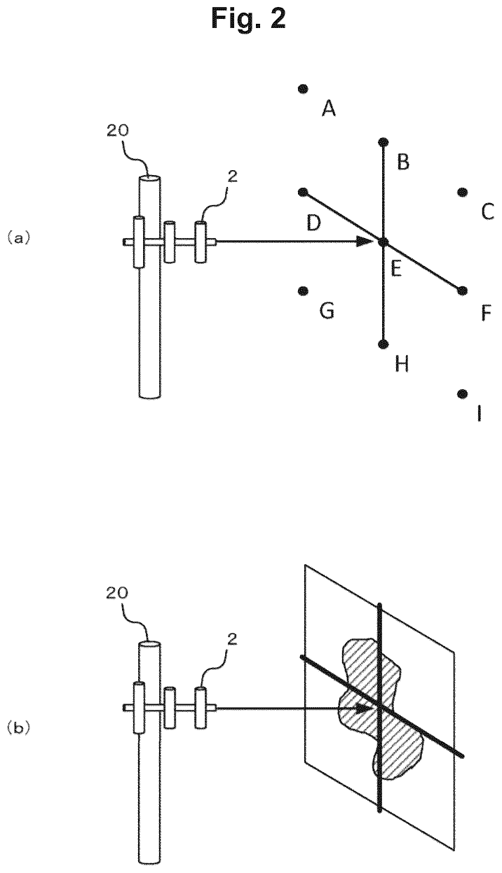

FIG. 2 shows diagrams illustrating a plane orthogonal to the reference straight line extending in the horizontal direction, used by the measurement unit 10. FIG. 2(a) is a diagram illustrating a plurality of different points (A to I) positioned on the plane orthogonal to the reference straight line extending in the horizontal direction. FIG. 2(b) is a diagram illustrating a result of the extraction of a range on the X-Y plane by the extraction unit 14 to be described later using the plurality of different points (A to I).

In FIG. 2, the straight line extending in the horizontal direction from the directional antenna 2 toward the point E is defined as the reference straight line.

In a case where the directional antenna 2 is directed to each of the plurality of different points (A to I), the angle measurement unit 11 measures the azimuth angle and elevation angle of the directional antenna 2, and outputs the azimuth angle and elevation angle to the storage unit 12.

The storage unit 12 is a memory or the like storing the information used by the radio wave status output device 1, and stores information output from the measurement unit 10, the angle measurement unit 11, and the like, predetermined information, and the like.

The calculation unit 13 calculates an approximate curved surface corresponding to either the reception power or C/N value at the position of each of the plurality of different points on the X-Y plane, based on an assumption that the azimuth angle and the elevation angle measured by the angle measurement unit 11 with respect to each of the plurality of different points are a value of the X-axis and a value of the Y-axis, respectively, and that the reception power or the C/N value measured by the measurement unit 10 is a value of the Z-axis, and outputs the calculated approximate curved surface to the extraction unit 14.

The extraction unit 14 extracts, from the approximate curved surface calculated by the calculation unit 13, a range on the X-Y plane in which the value of the Z-axis is equal to or greater than a predetermined threshold, and outputs the extracted range to the output unit 15. In addition, the extraction unit 14 may extract ranges on the X-Y plane in which the value of the Z-axis is equal to or greater than each of a plurality of thresholds.

For example, the extraction unit 14 extracts a range (a shaded range) on the X-Y plane illustrated in FIG. 2(b) and outputs the extracted range to the output unit 15.

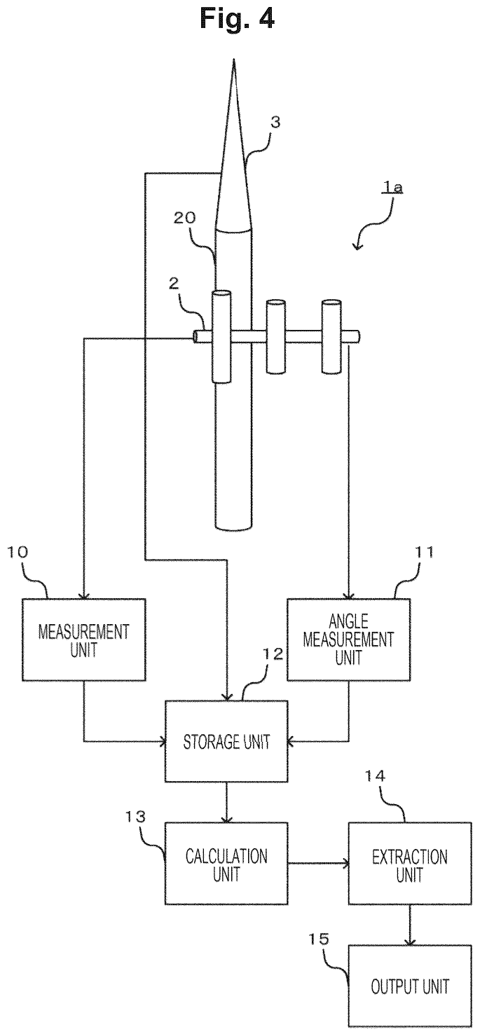

The threshold used by the extraction unit 14 may be determined based on reception power or a C/N value of the radio wave received by an omni antenna 3 (see FIG. 4) disposed in the vicinity of the directional antenna 2.

The output unit 15 outputs the range on the X-Y plane extracted by the extraction unit 14 by displaying, for example. For example, the output unit 15 may output the range on the X-Y plane in which the value of the Z-axis is equal to or greater than a predetermined threshold by displaying it in a color different from other ranges.

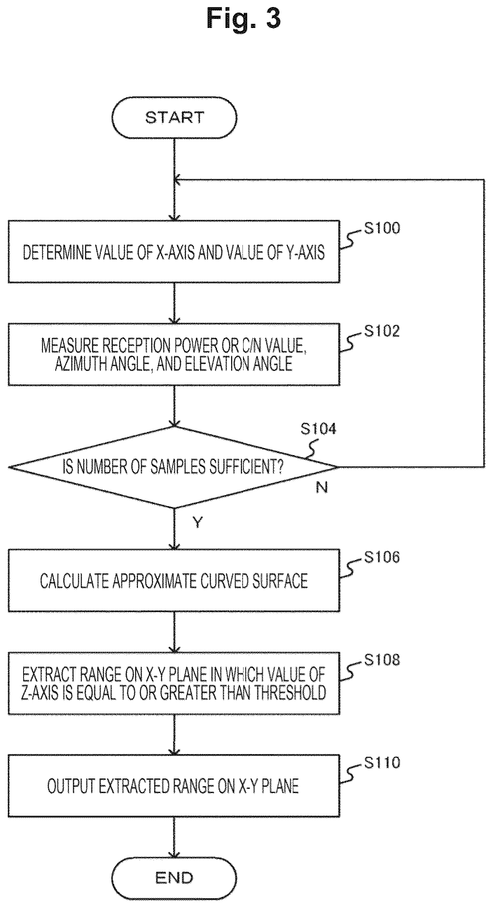

FIG. 3 is a flowchart showing an operation example of the radio wave status output device 1. As shown in FIG. 3, the radio wave status output device 1 determines the X-axis and the Y-axis shown in FIG. 2(a) in Step 100 (S100).

In Step 102 (S102), the radio wave status output device 1 measures the reception power or C/N value by the directional antenna 2, the azimuth angle, and the elevation angle.

In Step 104 (S104), the radio wave status output device 1 determines whether the number of samples of the points on the X-Y plane is sufficient, and in a case where the number of samples is sufficient (S104: Yes), the process proceeds to S106. In a case where the number of samples is not sufficient (S104: No), the process returns to S100.

In Step 106 (S106), the calculation unit 13 calculates an approximate curved surface corresponding to either the reception power or C/N value at the position of each of the plurality of different points on the X-Y plane, based on an assumption that the azimuth angle and the elevation angle measured by the angle measurement unit 11 with respect to each of the plurality of different points are a value of the X-axis and a value of the Y-axis, respectively, and that the reception power or the C/N value measured by the measurement unit 10 is a value of the Z-axis.

In Step 108 (S108), the extraction unit 14 extracts, from the approximate curved surface calculated by the calculation unit 13, a range on the X-Y plane in which the value of the Z-axis is equal to or greater than a predetermined threshold.

In Step 110 (S110), the output unit 15 outputs the range on the X-Y plane extracted by the extraction unit 14.

An operator can easily grasp the three-dimensional radio wave status by referring to the range on the X-Y plane output from the radio wave status output device 1.

Next, a modification example of the radio wave status output device 1 will be described. FIG. 4 is a diagram showing a configuration example of a modification example (radio wave status output device 1a) of the radio wave status output device 1.

As shown in FIG. 4, the radio wave status output device 1a according to one embodiment has, for example, a directional antenna 2, an omni antenna 3, a measurement unit 10, an angle measurement unit 11, a storage unit 12, a calculation unit 13, an extraction unit 14, and an output unit 15. Note that substantially the same components as those described above with reference to FIG. 1 are denoted by the same reference numerals.

The omni antenna 3 is disposed in the vicinity of the directional antenna 2. In addition, the omni antenna 3 is configured so that the reception power or C/N value of the radio wave received in advance is stored in the storage unit 12.

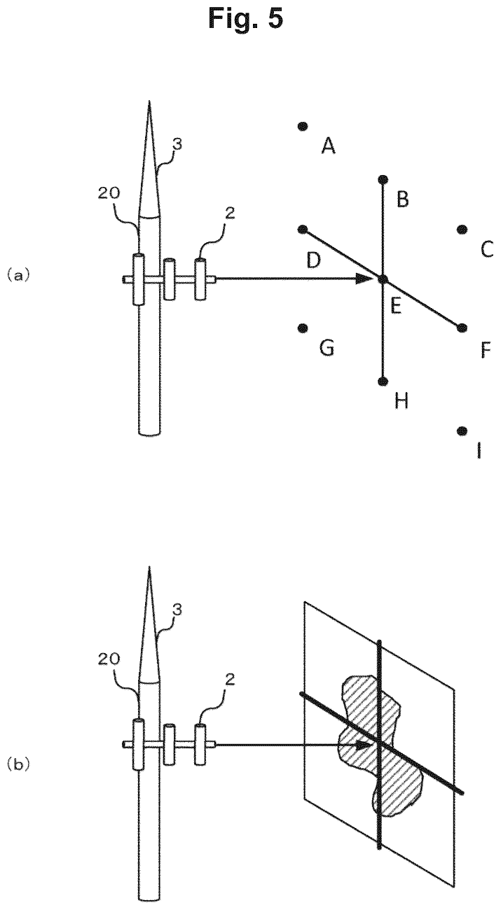

FIG. 5 shows diagrams illustrating a plane orthogonal to a reference straight line extending in the horizontal direction, used by the measurement unit 10. FIG. 5(a) is a diagram illustrating a plurality of different points (A to I) positioned on the plane orthogonal to the reference straight line extending in the horizontal direction. FIG. 5(b) is a diagram illustrating a result of the extraction of a range on the X-Y plane by the extraction unit 14 to be described later using the plurality of different points (A to I).

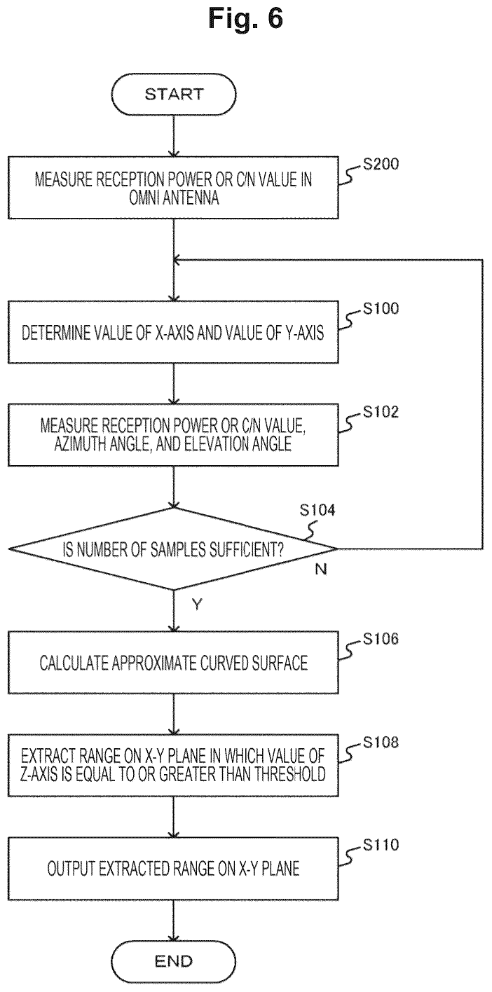

In FIG. 5, the straight line extending in the horizontal direction from the directional antenna 2 toward the point E is defined as the reference straight line. FIG. 6 is a flowchart showing an operation example of the radio wave status output device 1a. As shown in FIG. 6, in Step 200 (S200), the radio wave status output device 1a measures the reception power or C/N value in the omni antenna 3.

Then, the radio wave status output device 1a determines a threshold to be used by the extraction unit 14 based on the reception power or C/N value of the radio wave received by the omni antenna 3, and then performs the same processing as the radio wave status output device 1.

Some or all of the functions of the radio wave status output devices 1 and 1a may be configured by hardware such as a programmable logic device (PLD) or a field programmable gate array (FPGA), or may be configured as a program executed by a processor such as a CPU.

For example, the radio wave status output devices 1 and 1a can be implemented by using a computer and a program, and the program can be recorded in a storage medium or provided through a network.

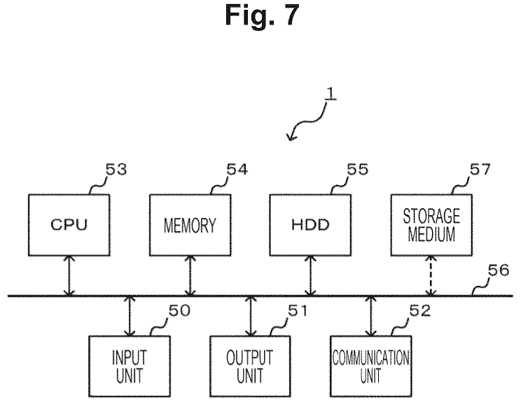

FIG. 7 is a diagram showing a hardware configuration example of the radio wave status output device 1 according to one embodiment. As illustrated in FIG. 7, the radio wave status output device 1 has a function of a computer in which an input unit 50, an output unit 51, a communication unit 52, a CPU 53, a memory 54, and an HDD 55 are connected via a bus 56. In addition, the radio wave status output device 1 can input and output data to and from a computer-readable storage medium 57.

The input unit 50 is, for example, a keyboard, a mouse, or the like. The output unit 51 is, for example, a display device such as a display. The communication unit 52 is, for example, a network interface or the like.

The CPU 53 controls the units constituting the radio wave status output device 1 and performs predetermined processing or the like. The memory 54 and the HDD 55 correspond to the above-described storage unit 12 that stores data and the like.

The storage medium 57 can store a program or the like executing a function of the radio wave status output device 1. The architecture that configures the radio wave status output device 1 is not limited to the example shown in FIG. 7.

As described above, in the radio wave status output devices 1 and 1a according to one embodiment, the range on the X-Y plane extracted by the extraction unit 14 is output from the output unit 15, and thus it is possible to easily grasp the three-dimensional radio wave status.

### REFERENCE SIGNS LIST

1 Radio wave status output device
2 Directional antenna
3 Omni antenna
10 Measurement unit
11 Angle measurement unit
12 Storage unit
13 Calculation unit
14 Extraction unit
15 Output unit
20 Fixing unit
50 Input unit
51 Output unit
52 Communication unit
53 CPU
54 Memory
55 HDD
56 Bus
57 Storage medium

1. A radio wave status output device comprising:
measurement circuitry configured to measure, in a case where a directional antenna is directed to each of a plurality of different points positioned on a plane orthogonal to a reference straight line extending in a horizontal direction, each reception power or a C/N value of a radio wave received by the directional antenna;
angle measurement circuitry configured to measure an azimuth angle and an elevation angle of the directional antenna in a case where the directional antenna is directed to each of the plurality of different points;
calculation circuitry configured to calculate an approximate curved surface corresponding to either the reception power or C/N value at a position of each of the plurality of different points on an X-Y plane, based on an assumption that the azimuth angle and the elevation angle measured by the angle measurement circuitry with respect to each of the plurality of different points are a value of an X-axis and a value of a Y-axis, respectively, and that the reception power or the C/N value measured by the measurement circuitry is a value of a Z-axis;
extraction circuitry configured to extract, from the approximate curved surface calculated by the calculation circuitry, a range on the X-Y plane in which the value of the Z-axis is equal to or greater than a predetermined threshold; and
output circuitry configured to output the range on the X-Y plane extracted by the extraction circuitry.

2. The radio wave status output device according to claim 1,
wherein the threshold is determined based on reception power or a C/N value of a radio wave received by an omni antenna disposed in the vicinity of the directional antenna.

3. The radio wave status output device according to claim 1,
wherein the extraction circuitry extract on the X-Y plane in which the value of the Z-axis is equal to or greater than each of a plurality of thresholds.

4. The radio wave status output device according to claim 1,
wherein the output circuitry output the range on the X-Y plane in which the value of the Z-axis is equal to or greater than a predetermined threshold by displaying it in a color different from that of other ranges.

5. A radio wave status output method comprising:
measuring, in a case where a directional antenna is directed to each of a plurality of different points positioned on a plane orthogonal to a reference straight line extending in a horizontal direction, each reception power or a C/N value of a radio wave received by the directional antenna;
measuring an azimuth angle and an elevation angle of the directional antenna in a case where the directional antenna is directed to each of the plurality of different points;
calculating an approximate curved surface corresponding to either the reception power or C/N value at a position of each of the plurality of different points on an X-Y plane, based on an assumption that the azimuth angle and the elevation angle measured with respect to each of the plurality of different points are a value of an X-axis and a value of a Y-axis, respectively, and that the reception power or the C/N value measured is a value of a Z-axis;
extracting, from the calculated approximate curved surface, a range on the X-Y plane in which the value of the Z-axis is equal to or greater than a predetermined threshold; and
outputting the extracted range on the X-Y plane.

6. The radio wave status output method according to claim 5,
wherein the threshold is determined based on reception power or a C/N value of a radio wave received by an omni antenna disposed in the vicinity of the directional antenna.

7. The radio wave status output method according to claim 5,
wherein, in extracting, ranges on the X-Y plane in which the value of the Z-axis is equal to or greater than each of a plurality of thresholds are extracted.

8. A non-transitory computer-readable storage medium storing a radio wave status output program for causing a computer to function as each circuitry of the radio wave status output device according to claim 1.
